(19) United States
(12) Patent Application Publication
(10) Pub. No.: US 2011/0220506 A1
(43) Pub. Date: Sep. 15, 2011

(54) RECOVERY OF MATERIALS FROM MIXTURES WITH IONIC LIQUIDS

(75) Inventors: Manish S. Kelkar, Wilmington, DE (US); Mark A. Scialdone, West Grove, PA (US); Mark Brandon Shiflett, Wilmington, DE (US)

(73) Assignee: E. I. DU PONT DE NEMOURS AND COMPANY, Wilmington, DE (US)

(21) Appl. No.: 13/045,617

(22) Filed: Mar. 11, 2011

Related U.S. Application Data
(60) Provisional application No. 61/313,328, filed on Mar. 12, 2010.

(51) Int. Cl. B03C 9/00

(52) U.S. Cl. 204/573

(57) ABSTRACT

A method for recovering for a material such as an absorbed solute from an ionic liquid is described. In the method, an electric field is applied to the ionic liquid to release the absorbed solute.

This application claims priority under 35 U.S.C. §119(e) from, and claims the benefit of, U.S. Provisional Application No. 61/313,328, filed Mar. 12, 2010, which is by this reference incorporated in its entirety as a part hereof for all purposes.

### TECHNICAL FIELD

The invention relates to the field of ionic liquids. More specifically, the invention relates to a method for recovering materials such as an absorbed solute from an ionic liquid by applying an electric field to the ionic liquid.

### BACKGROUND

Ionic liquids are attracting increasing attention in many fields. One area of interest is the use of ionic liquids as absorbents in separations. For example, ionic liquids have been used as an absorbent for gases such as ammonia, methane, sulfur dioxide, hydrogen sulfide, and carbon dioxide, and for liquids such as hydrofluorocarbons, olefins, aldehydes, alcohols, and water. One such application involves the capture of carbon dioxide from gaseous streams (Chinn et al., U.S. Pat. No. 7,527,775; Davis, International Patent Application No. WO 2008/122030).

Development of economically viable carbon dioxide (CO₂) capture processes is becoming increasingly important as concerns over greenhouse gas emissions continue to receive worldwide attention. The need for affordable post-combustion CO₂ capture processes for existing coal-fired power plants is of particular interest in the United States because these plants generate approximately 50% of the nation's electricity and produce about 30% of the CO₂ emissions.

Typically, the absorbed solute is recovered from the ionic liquid by heating. However, for some applications (e.g., the capture of carbon dioxide from flue gas using ionic liquids), the use of heat may not provide an economically viable commercial process.

Therefore, the need exists for an improved method to recover absorbed solutes from ionic liquids which is more energy efficient than using heat energy.

### SUMMARY

The present invention addresses the stated need by providing a method for recovering materials such as an absorbed solute from ionic liquids by applying an electric field to the ionic liquid.

Accordingly, in one embodiment the invention provides a method for recovering materials such as an absorbed solute from an ionic liquid comprising the steps of:
a) providing an ionic liquid containing materials such as an absorbed solute;
b) applying an electric field to the ionic liquid for a time sufficient to release at least a portion of the materials from the ionic liquid; and
c) recovering the released materials;

wherein said ionic liquid comprises an anion and a cation, said cation is selected from the group consisting of cations represented by the structures of the following formulae:

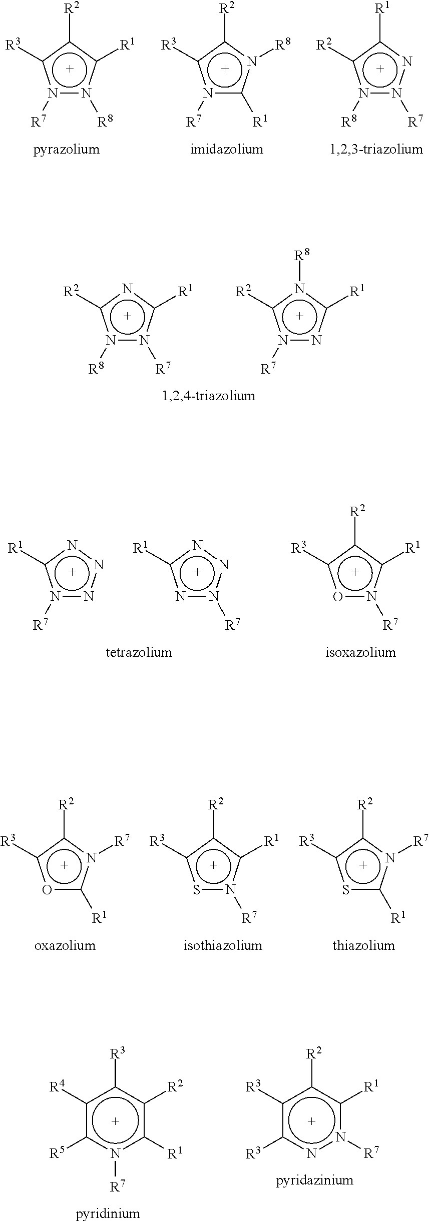

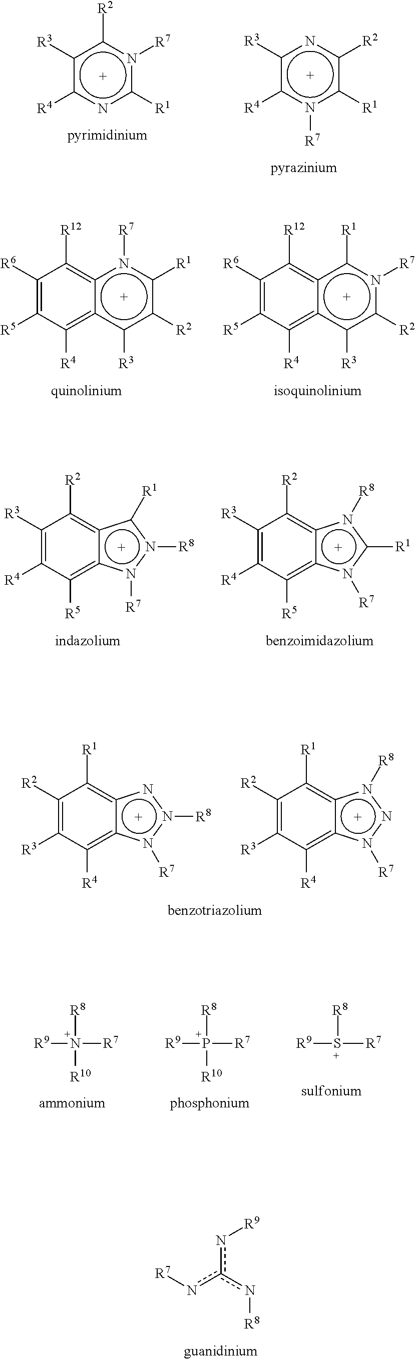

wherein:
a) R¹, R², R³, R⁴, R⁵, R⁶, and R¹² are independently selected from the group consisting of:
   (i) H,
   (ii) halogen such as Cl, Br, F, I,
   (iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
   (iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (v) C₆ to C₂₀ unsubstituted aryl, or C₆ to C₂₅ unsubstituted heteroaryl having one to three heteroatoms independently selected from the group consisting of O, N, Si and S;
   (vi) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (A) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
      (B) OH,
      (C) NH₂, and
      (D) SH;
   (vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
   (viii)

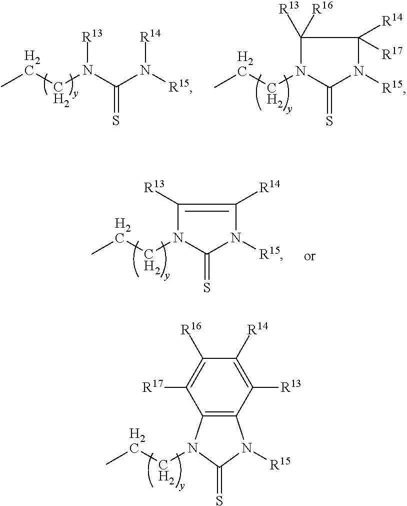

wherein y is 0-15, and R¹³, R¹⁴, R¹⁵, R¹⁶, and R¹⁷ are independently selected from the group consisting of: (i), (iii), (iv), (v), (vi) and (vii) as set forth above;
b) R⁷, R⁸, R⁹, and R¹⁰ are independently selected from the group consisting of:
   (ix) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
   (x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (xi) C₆ to C₂₅ unsubstituted aryl, or C₆ to C₂₅ unsubstituted heteroaryl having one to three heteroatoms independently selected from the group consisting of O, N, Si and S; and
   (xii) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (E) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
      (F) OH,
      (G) NH₂, and
      (H) SH;
   (xiii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
   (xiii)

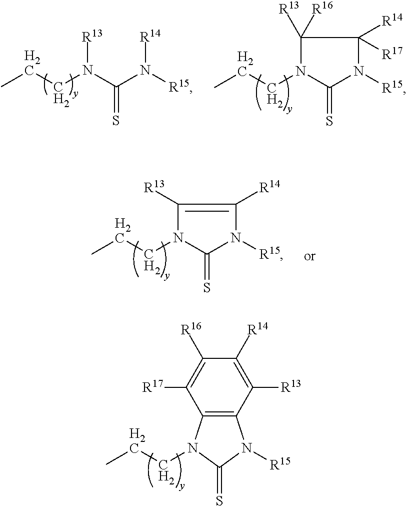

wherein y is 0-15, and R¹³, R¹⁴, R¹⁵, R¹⁶, and R¹⁷ are independently selected from the group consisting of: (i), (iii), (iv), (v), (vi) and (vii) as set forth above; and
c) optionally at least two of R¹, R², R³, R⁴, R⁵, R^{6,} R⁷, R⁸, R⁹, and R¹⁰ can together form a cyclic or bicyclic alkanyl or alkenyl group.

### DETAILED DESCRIPTION

As used above and throughout the description of the invention, the following terms, unless otherwise indicated, shall be defined as follows:

The term “ionic liquid” refers to an organic salt that is fluid at or below about 100° C.

The term “solute”, as used herein, refers to a liquid or gas absorbed in an ionic liquid.

The term “DC” means direct current.

The term “AC” means alternating current.

The term “Hz” means hertz (i.e., sec⁻¹).

The term “flue gas”, as used herein, refers to the combustion exhaust gas produced by power plants, particularly coal-fired power plants.

The term “ionic liquid electrospray plume” refers to a hyperbolic cone comprising nanodroplets of an ionic liquid formed by applying a high voltage between an ionic liquid housed in an electrospray nozzle and a counter electrode.

The term “nanodroplets”, as used herein, refers to droplets of an ionic liquid having a diameter of about 100 nanometers to about 1000 nanometers.

Disclosed herein is a method for recovering materials such as an absorbed solute from an ionic liquid by applying an electric field to the ionic liquid. The application of an electric field changes the inherent structure of the ionic liquid (Wang, J. Phys. Chem. B, 113:11058-11060, 2009), thereby releasing the materials such as absorbed solute from the intermolecular free volume of the ionic liquid (Shi et al. J. Phys. Chem. B, 112:29045-2055, 2008, and J. Phys. Chem. B, 112:16710-16720, 2008). The method is widely applicable to recovering solutes absorbed by ionic liquids and is particularly suitable for recovering carbon dioxide and/or sulfur dioxide captured from flue gas using ionic liquids.

### Ionic Liquids

Ionic liquids suitable for use as disclosed herein can, in principle, be any ionic liquid that absorbs the solute of interest; however, ionic liquids that have minimal absorption of the solute of interest will be less effective. Ideally, ionic liquids having high absorption of the solute of interest are desired for efficient use as described herein. Additionally, mixtures of two or more ionic liquids may be used.

Many ionic liquids are formed by reacting a nitrogen-containing heterocyclic ring, preferably a heteroaromatic ring, with an alkylating agent (for example, an alkyl halide) to form a cation. Examples of suitable heteroaromatic rings include substituted pyridines and imidazoles. These rings can be alkylated with virtually any straight, branched or cyclic C₁₋₂₀ alkyl group, but preferably, the alkyl groups are C₁₋₁₆ groups. Various other cations such as ammonium, phosphonium, sulfonium, and guanidinium may also be used for this purpose. Ionic liquids suitable for use herein may also be synthesized by salt metathesis, by an acid-base neutralization reaction or by quaternizing a selected nitrogen-containing compound; or they may be obtained commercially from several companies such as Merck (Darmstadt, Germany), BASF (Mount Olive, N.J.), Fluka Chemical Corp. (Milwaukee, Wisc.), and Sigma-Aldrich (St. Louis, Mo.). For example, the synthesis of many ionic liquids is described by Shiflett et al. (U.S. Patent Application Publication No. 2006/0197053, which is by this reference incorporated as a part hereof for all purposes).

Representative examples of ionic liquids suitable for use herein are included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references cited therein); and U.S. 2004/0133058 and U.S. 2008/0028777 (each of which is by this reference incorporated as a part hereof for all purposes). In one embodiment, a library, i.e., a combinatorial library, of ionic liquids may be prepared, for example, by preparing various alkyl derivatives of a quaternary ammonium cation, and varying the associated anions.

Ionic liquids suitable for use herein comprise an anion and a cation, the cation is selected from the group consisting of cations represented by the structures of the following formulae:

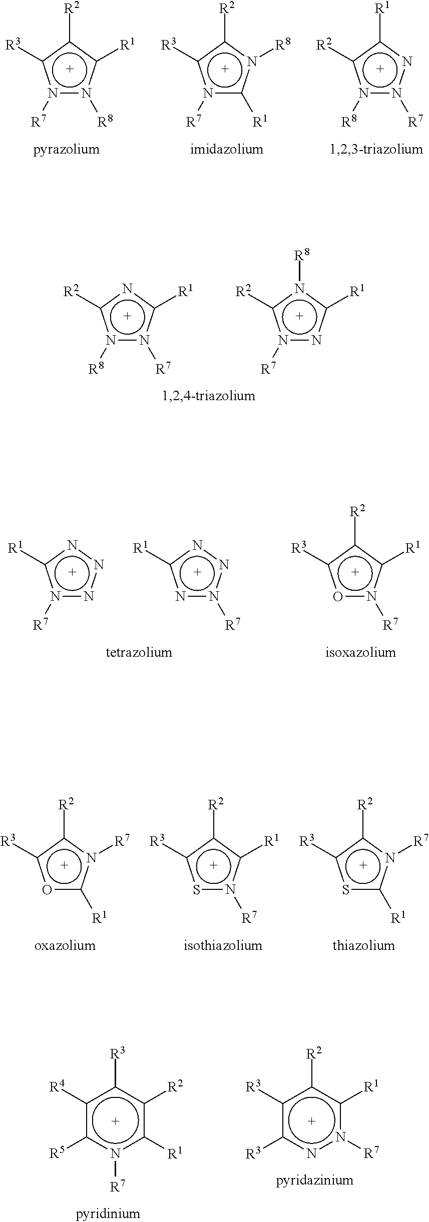

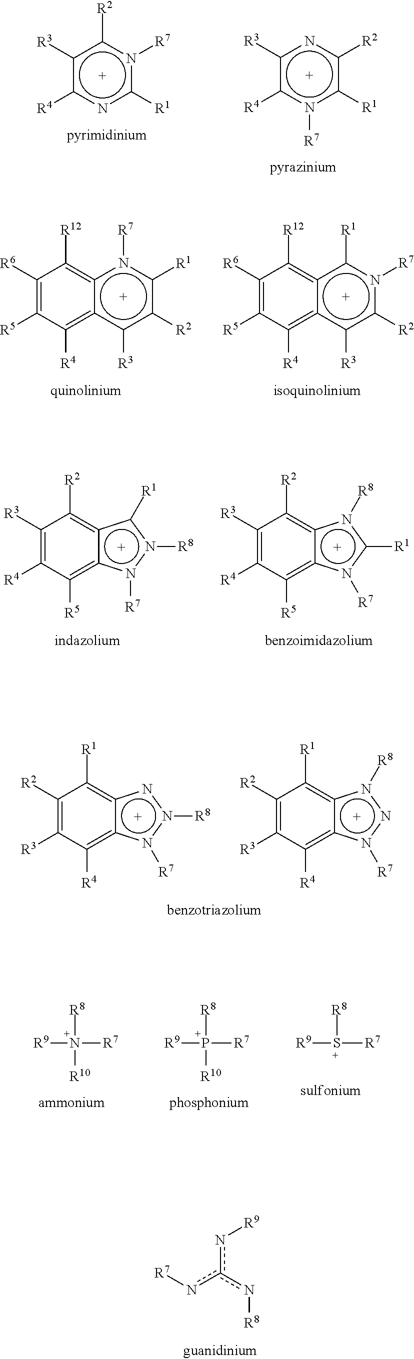

wherein:
a) R¹, R², R³, R⁴, R⁵, R⁶, and R¹² are independently selected from the group consisting of:
   (i) H,
   (ii) halogen,
   (iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
   (iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (v) C₆ to C₂₀ unsubstituted aryl, or C₆ to C₂₅ unsubstituted heteroaryl having one to three heteroatoms independently selected from the group consisting of O, N, Si and S;
   (vi) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (A) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
      (B) OH,
      (C) NH₂, and
      (D) SH;
   (vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
   (viii)

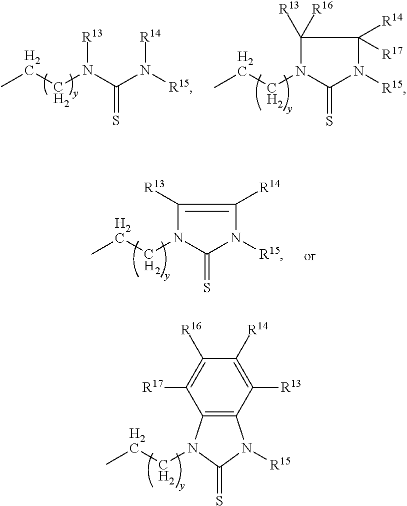

wherein y is 0-15, and R¹³, R¹⁴, R¹⁵, R¹⁶, and R¹⁷ are independently selected from the group consisting of: (i), (iii), (iv), (v), (vi) and (vii) as set forth above;
b) R⁷, R⁸, R⁹, and R¹⁰ are independently selected from the group consisting of:
   (ix) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
   (x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (xi) C₆ to C₂₅ unsubstituted aryl, or C₆ to C₂₅ unsubstituted heteroaryl having one to three heteroatoms independently selected from the group consisting of O, N, Si and S; and
   (xii) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (E) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
      (F) OH,
      (G) NH₂, and
      (H) SH;
   (xii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
   (xiii)

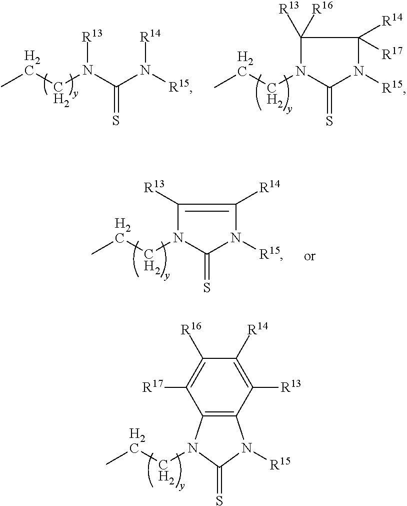

wherein y is 0-15, and R¹³, R¹⁴, R¹⁵, R¹⁶, and R¹⁷ are independently selected from the group consisting of: (i), (iii), (iv), (v), (vi) and (vii) as set forth above; and
c) optionally at least two of R¹, R², R³, R⁴, R⁵, R⁶, R⁷, R⁸, R⁹, and R¹⁰ can together form a cyclic or bicyclic alkanyl or alkenyl group.

In one embodiment, the ionic liquid comprises an anion selected from one or more members of the group consisting of: [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, , Cl⁻, Br, SCN⁻, and a fluorinated anion.

In one embodiment, the ionic liquid comprises a cation selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

In another embodiment, the ionic liquid comprises an anion selected from one or more members of the group consisting of acetate, aminoacetate, ascorbate, benzoate, catecholate, citrate, dialkylphosphate, formate, fumarate, gallate, glycolate, glyoxylate, iminodiacetate, isobutyrate, kojate, lactate, levulinate, oxalate, pivalate, propionate, pyruvate, salicylate, succinamate, succinate, tiglate, tetrafluoroborate, tetrafluoroethanesulfonate, tropolonate, [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]^{2 -}, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃], [CF₃CF₂OCF₂CF₂SO₃]⁻, [(CF₂HCF₂SO₂)₂N]₋, [(CF₃CFHCF₂SO₂)₂N]⁻, F⁻, and anions represented by the structure of the following formula:

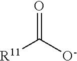

wherein R¹¹ is selected from the group consisting of:
(i) —CH₃, —C₂H₅, or C₃ to C₁₇ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₇ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₆ to C₁₇ unsubstituted heteroaryl having one to three heteroatoms independently selected from the group consisting of O, N, Si and S; and
(iv) C₆ to C₁₀ substituted aryl, or C₆ to C₁₇ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₃ to C₁₇ straight-chain, branched or cyclic alkane or alkene, optionally substituted with at least one member selected from the group consisting of Cl, Br, F, I, OH, NH₂ and SH,
   (B) OH,
   (C) NH₂, and
   (D) SH.

Particularly suitable ionic liquids for carbon dioxide and/or sulfur dioxide capture in the method disclosed herein are ionic liquids where at least one R-group substituent on the cation contains a thiourea, dihydrothioimidazole or thioimidazole. These thio-containing ionic liquids can be generically represented as the following four structures:

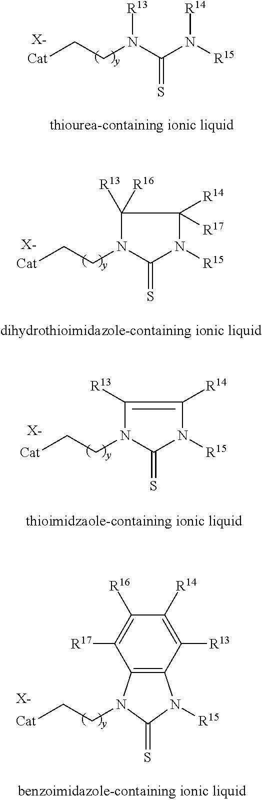

wherein “Cat” represents any of the cations listed above, X- represents any of the anions listed above, y is 0-15, and R¹³, R¹⁴, R¹⁵, R¹⁶, and R¹⁷ are independently selected from the group consisting of:
(a) H,
(b) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(c) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(d) C₆ to C₂₀ unsubstituted aryl, or C₆ to C₂₅ unsubstituted heteroaryl having one to three heteroatoms independently selected from the group consisting of O, N, Si and S;
(e) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
   (B) OH,
   (C) NH₂, and
   (D) SH; and
(f) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4.

These ionic liquids may by prepared, for example, from the amine-containing “task specific ionic liquids” (TSIL) described by Gutowski et al. (J. Am. Chem. Soc. 130:14690-14704, 2008) and Davis et al. (International Patent Application No. WO 2008/122030), and isothiocyanates according to the following reaction scheme:

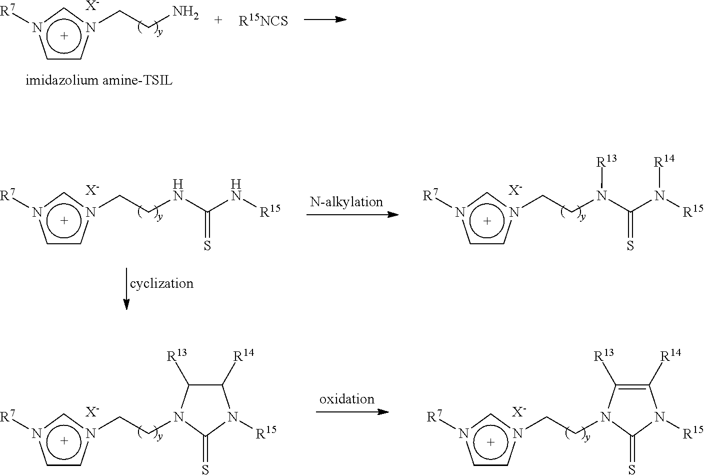

wherein X- represents any of the anions listed above, y is 0-15, and R⁷, R¹³, R¹⁴, and R¹⁵ are defined above. The thiourea ionic liquid adducts may be converted into heterocyclic thiones by cyclization.

A TSIL consisting of an immidazolium ion to which a primary amine moiety is covalently tethered was prepared by a process described in Bates et al, Volume 124, No. 6, 2002, Journal of the American Chemical Society, pages 926˜927 as follows: “The cation core is assembled by the reaction of 1-butylimidazole with 2-bromopropylamine hydrobromide in ethanol. After 24 hours under reflux, the ethanol is removed in vacuo, and the solid residue dissolved in a minimal quantity of water that is brought to ˜pH 8 by the addition, in small portions, of solid KOH. The product imidazolium bromide is then separated from the KBr byproduct by evaporation of the water, followed by extraction of the residue with ethanol-THF, in which the immidazolium salt is soluble. Subsequent ion-exchange with NaBF₄ in ethanol/water gives the product salt in 58% overall yield.”

Additives to Enhance CO₂ and/or SO₂ Absorption by Ionic Liquids

Various additives may be used to enhance the absorption of CO₂ and/or SO₂ by ionic liquids. The gases and gaseous mixtures referred to herein may include vapors (volatilized liquids), gaseous compounds and/or other gaseous elements. For example, neutral sulfur-based reagents, such as thioureas, thiones, and related compounds, may be used as CO₂ absorbent additives to ionic liquids. Various mixtures of these compounds may also be used. These compounds, while being potent nucleophiles, are less basic than amines, and generate a zwitterionic thiocarbonate upon reaction with CO₂ and/or SO₂ that could b reversed upon heating.

Suitable thioureas, imidazole thiones and benzoimidazole thiones are represented by the general structures:

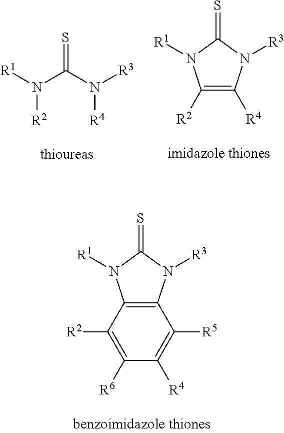

wherein R¹, R², R³, R⁴, R⁵, and R⁶ are defined above.

In one embodiment for the thioureas, R¹ is an electron rich aryl group, R² is a small alkyl group, R³ is H or an electron withdrawing group, and R⁴ is a long chain alkyl group. In another embodiment for the imidazole thiones and the benzoimidazole thiones, R¹ is an electron rich aryl group, R³ is H or an electron withdrawing group, and R² and R⁴, R⁵, and R⁶ are independently H, an alkyl group, or an aryl group.

Substituted thioureas may be prepared using the method described by Neville et al. (Org. Syn. Coll. 5:801, 1973). For example, a solution of cyclohexylamine in anhydrous benzene is added to silicon tetraisocyanate in anhydrous benzene. The mixture is heated and the benzene is removed; isopropyl alcohol is added to the residue, and the mixture is heated and filtered.

1,3-dialkylimidazole-2-thiones and benzoimidazole thiones may be prepared by thionation of imidazolium halides, as described by Benac et al. (Org. Syn. Coll. 7:195, 1990). For example, 1,3-dimethylimidazolium iodide, anhydrous potassium carbonate, sulfur and methanol are combined. The mixture is stirred, filtered, washed with dichloromethane and dried.

Method for Recovering Absorbed Solutes from Ionic Liquids

The method disclosed herein for recovering materials such as an absorbed solute from an ionic liquid comprises the following steps. The first step is to provide an ionic liquid containing materials such as an absorbed solute. The materials such as absorbed solute may be a liquid, such as for example an olefin, an aldehyde, an alcohol (e.g., ethanol, methanol, butanol, 1,3-propanediol), a hydrofluorocarbon (e.g., 1,1,1,2-tetrafluoroethane), and water, or a gas, such as for example ammonia, methane, sulfur dioxide, hydrogen sulfide, and carbon dioxide. In one embodiment, the absorbed gas is carbon dioxide and/or sulfur dioxide. Any of the ionic liquids described above may be used. In addition, a mixture of two or more ionic liquids may be used. The ionic liquid may also comprise at least one additive to enhance absorption of the solute, as described above. The solute may be absorbed by contacting with the ionic liquid as is known in the art. For example, the solute may be contacted with the absorbing ionic liquid in an absorption column.

Then, an electric field is applied to the ionic liquid containing the absorbed solute for a time sufficient to release at least a portion of the absorbed solute. The electric field may be a DC (direct current) electric field, for example having a field strength of about 1,000 V/m to about 100,000 V/m. Alternatively, the electric field may be an AC (alternating current) electric field, for example having a field strength of about 1,000 V/m to about 100,000 V/m and a frequency of about 0.1 Hz to about 100 Hz. Heat may also be applied to the ionic liquid containing the absorbed solute concurrently with the electric field in order to increase the amount of the solute recovered or to decrease the time required. The released solute may be recovered using methods known in the art. For example, the released gas may be collected and liquefied by pressurizing for storage.

In one embodiment, the method disclosed herein is used to recover carbon dioxide and/or sulfur dioxide captured from a gaseous mixture such as a flue gas using ionic liquids. In this embodiment, the ionic liquid containing absorbed carbon dioxide is provided by exposing the flue gas to an ionic liquid, for example in an absorption column. The ionic liquid may be in the form of an ionic liquid electrospray plume comprising nanodroplets of an ionic liquid, which is formed by passing the ionic liquid through an electrospray nozzle and applying an electric field between the electrospray nozzle and a counter electrode. The ionic liquid electrospray plume may be formed using a DC or AC electric field having a field strength of about 10 V/cm to about 1000 V/cm. For the AC electric field, a frequency of about 0.1 Hz to about 100 Hz may be used. The electrospray plume may be formed using a system such as that described by Gu et al., U.S. Patent Application Publication No. 2009/0235817 (which is by this reference incorporated as a part hereof for all purposes).

The carbon dioxide and/or sulfur dioxide captured by the ionic liquid is then recovered by applying an electric field to the ionic liquid, as described above, thereby releasing at least a portion of the carbon dioxide. The released carbon dioxide and/or sulfur dioxide may be recovered by methods known in the art. For example, the released carbon dioxide may be liquefied by pressurizing for storage.

### EXAMPLES

The present invention is further illustrated in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “mL” means milliliter(s), “m” means meter(s), “mm” means millimeter(s), “V” means volt(s).

### Example 1 (Prophetic)

Recovery of Absorbed Carbon Dioxide from an Ionic Liquid Using a DC Electric Field

This prophetic example illustrates the recovery of absorbed carbon dioxide from an ionic liquid by the application of a DC electric field.

A 20 mL glass vial (Vial A) is filled with approximately 2 mL of ionic liquid (e.g. [Bmim] [Ac]) at room temperature under a nitrogen atmosphere. The weight of the ionic liquid in the vial is measured. Vial A is then closed with a cap to avoid contact with air. Vial A is then transferred to a carbon dioxide absorption apparatus where the cap of Vial A is replaced with a specially fabricated cap which has two tubes attached to it.

The carbon dioxide absorption apparatus contains a temperature-controlled block and a source of carbon dioxide with tubing, valves, and flow meter for delivering the carbon dioxide to the vial. The attached tubes act as gas inlet and outlet. Vial A is then inserted in the block which is maintained at 25° C. The carbon dioxide flow is started and the ionic liquid is allowed to come in contact with the gas. A sufficient time is allowed for the ionic liquid to reach equilibrium by measuring the weight of the vial periodically. After attainment of equilibrium, Vial A is removed from the apparatus and the specially fabricated cap is replaced by a regular cap to avoid contact with the air. At this point, the weight of ionic liquid in Vial A is measured to calculate the amount of carbon dioxide absorbed in the ionic liquid.

Two equal length pieces of copper tape are wrapped around Vial A from outside such that there is about 1 mm separation between the two tapes at both ends. Alternatively, one can wrap the entire circumference of Vial A with copper tape and then remove two 1 mm slices from diagonally opposite places. The height of the tape from the bottom of Vial A is matched with the height of the ionic liquid inside the vial. One piece of the copper tape is then connected to a negative electrode of an external DC supply while the other piece of the copper tape is connected to the positive electrode of the same supply. The regular cap on Vial A is replaced with a specially fabricated cap with one attached tube. The open end of the tube is placed in a bubbler. This attachment avoids the buildup of pressure inside the vial. A potential gradient or voltage is applied (1,000-100,000 V/m) between the two tapes in order to generate a DC electric field inside Vial A for specified amount of time (e.g. 15 min). At the end of the specified time, Vial A is again fitted with the original regular cap and the weight of the ionic liquid inside the vial is measured.

The same series of steps with the exception of the application of the electric field, is also carried out on a different vial (Vial B) (at the same time) to gauge the effects of environmental conditions on the desorption of the carbon dioxide from the ionic liquid. The difference between the weights of Vial A and Vial B is calculated to determine the amount of carbon dioxide that is released due to the application of the electric field.

### Example 2 (Prophetic)

Recovery of Absorbed Carbon Dioxide from an Ionic Liquid Using an AC Electric Field

This prophetic example illustrates the recovery of absorbed carbon dioxide from an ionic liquid by the application of an AC electric field.

The method described in Example 1 is used, except that an AC electric field is used to release the absorbed carbon dioxide. Specifically, the tapes on Vial A are connected to an external AC supply to generate an electric field (1,000-100,000 V/m) inside Vial A at a specified frequency (0.1-100 Hz) for a specified amount of time (e.g. 15 min). At the end of the specified time, Vial A is again fitted with the original regular cap and the weight of the ionic liquid inside the vial is measured.

Without wishing to be bound by any particular theory, it is believed that the R group substituents on the nitrogen are involved in the capture reaction, the temperature needed to reverse the reaction, and the solubility of these species in ionic liquids. Furthermore, the non-bonding ionic interaction between the cation and anion in the ionic liquid or other additives present and the zwitterionic carbonates is also involved in the overall thermodynamics of this chemistry.

Various materials suitable for use herein may be made by processes known in the art, and/or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In the various embodiments of this invention, an ionic compound formed by selecting any of the individual cations described or disclosed herein, and by selecting any of the individual anions described or disclosed herein, may be used for the purposes hereof. Correspondingly, in yet other embodiments, a subgroup of ionic liquids formed by selecting (i) a subgroup of any size of cations, taken from the total group of cations described and disclosed herein in all the various different combinations of the individual members of that total group, and (ii) a subgroup of any size of anions, taken from the total group of anions described and disclosed herein in all the various different combinations of the individual members of that total group, may be used for the purposes hereof. In forming an ionic compound, or a subgroup of ionic compounds, by making selections as aforesaid, the ionic compound or subgroup will be identified by, and used in, the absence of the members of the group of cations and/or the group of anions that are omitted from the total group thereof to make the selection; and, if desirable, the selection may thus be made in terms of the members of one or both of the total groups that are omitted from use rather than the members of the group (s) that are included for use.

Each of the formulae shown herein describes each and all of the separate, individual compounds and compositions that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds and compositions may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, composition or plurality of compounds or compositions, may in such event be characterized by a definition of one or more of the variable radicals, substituents or numerical coefficents that refers to the whole group of the prescribed range for that variable but where the member(s) omitted to form the subgroup are absent from the whole group.

Other related systems, materials and methods for the removal of CO₂ or SO₂ from a gaseous mixture are disclosed in the following concurrently-filed U.S.

provisional patent applications:

| 61/313,298, 61/414,532, 61/416,421; | | 61/313,173; |
|---|---|---|
| 61/313,181; | 61/313,322; | 61/313,328; |
| 61/313,312; | 61/313,183; and | 61/313,191; |

each of which is by this reference incorporated in its entirety as a part hereof for all purposes.

What is claimed is:

1. A method for recovering an absorbed solute from an ionic liquid comprising the steps of:
a) providing an ionic liquid containing an absorbed solute;
b) applying an electric field to the ionic liquid for a time sufficient to release at least a portion of the absorbed solute from the ionic liquid; and
c) recovering the released material;
wherein said ionic liquid comprises an anion and a cation, said cation is selected from the group consisting of cations represented by the structures of the following formulae: 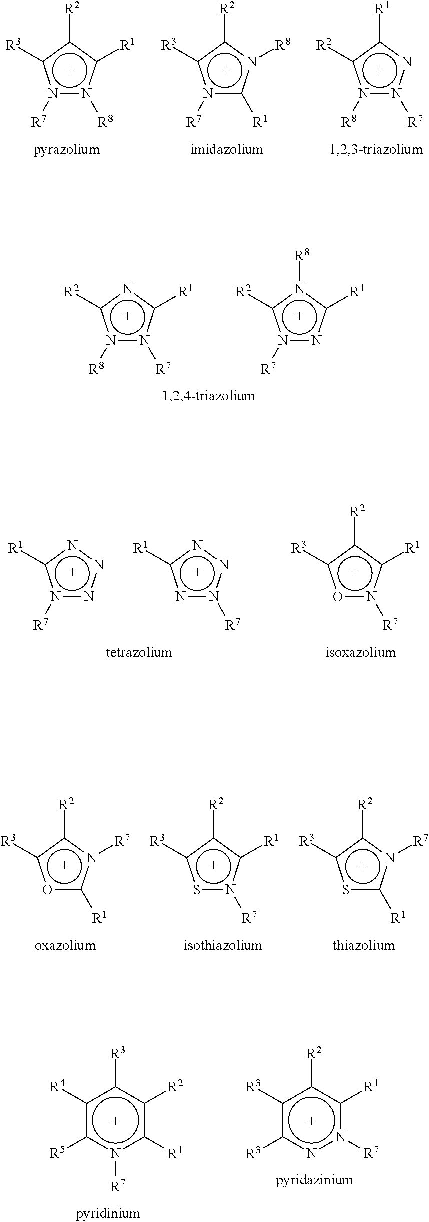 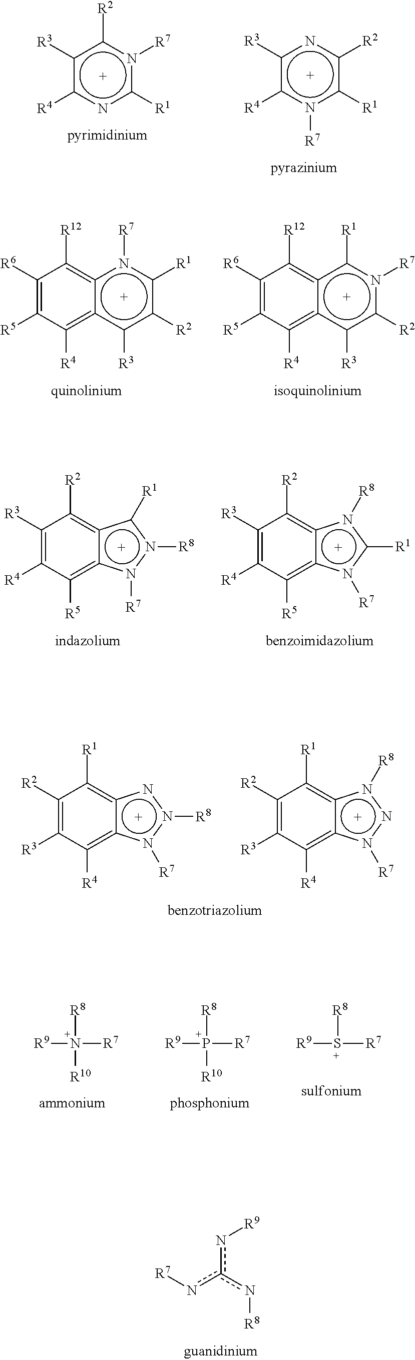
wherein:
a) R₁, R², R³, R⁴, R⁵, R⁶, and R¹² are independently selected from the group consisting of:
(i) H,
(ii) halogen,
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₆ to C₂₅ unsubstituted heteroaryl having one to three heteroatoms independently selected from the group consisting of O, N, Si and S;
(vi) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
(A) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
(B) OH,
(C) NH₂, and
(D) SH;
(vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(viii) 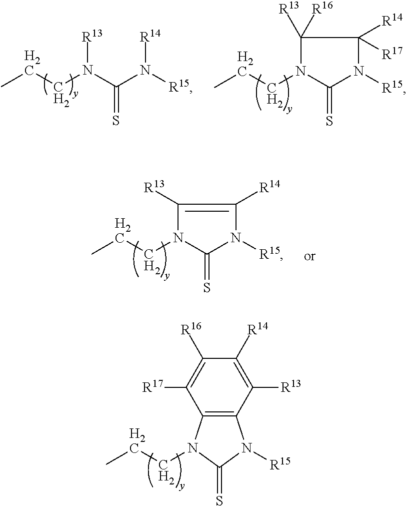
wherein y is 0-15, and R¹³, R¹⁴, R¹⁵, R¹⁶ , and R¹⁷ are independently selected from the group consisting of: (i), (iii), (iv), (v), (vi) and (vii) as set forth above;
b) R⁷, R⁸, R⁹, and R¹⁰ are independently selected from the group consisting of:
(ix) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₅ unsubstituted aryl, or C₆ to C₂₅ unsubstituted heteroaryl having one to three heteroatoms independently selected from the group consisting of O, N, Si and S; and
(xii) C₆ to C₂₅ substituted aryl, or C₆ to C₂₅ substituted heteroaryl having one to three heteroatoms independently selected from the group consisting of O, N, Si and S; and
wherein said substituted aryl or substituted heteroaryl has one to three substituents independently selected from the group consisting of:
(E) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
(F) OH,
(G) NH₂, and
(H) SH;
(xii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and 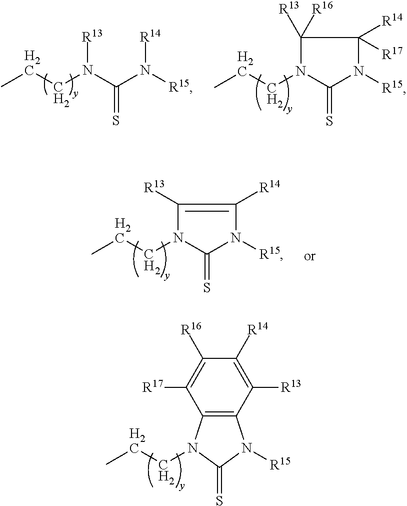
wherein y is 0-15, and R¹³, R¹⁴, R¹⁵, R¹⁶, and R¹⁷ are independently selected from the group consisting of: (i), (iii), (iv), (v), (vi) and (vii) as set forth above; and
c) optionally at least two of R¹, R², R³, R⁴, R⁵, R⁶, R⁷, R⁸, R⁹, and R¹⁰ can together form a cyclic or bicyclic alkanyl or alkenyl group.

2. The method of claim 1 wherein the electric field is a direct current electric field.

3. The method according to claim 2 wherein the direct current electric field has a field strength of about 1,000 V/m to about 100,000 V/m.

4. The method according to claim 1 wherein the electric field is an alternating current electric field.

5. The method according to claim 4 wherein the alternating current electric field has a field strength of about 1,000 V/m to about 100,000 V/m and a frequency of about 0.1 Hz to about 100 Hz.

6. The method according to claim 1 wherein the absorbed solute is carbon dioxide and/or sulfur dioxide.

7. The method according to claim 1 wherein the anion is selected from one or more members of the group consisting of: [CH₃CO₂]⁻, [HSO_{4]}⁻, [CH₃OSO₃]⁻, [C₂H₅OSO₃]⁻, [AlCl₄]⁻, [CO_{3]}²⁻, [HCO_{3]}⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO_{4]}⁻, [HSO₃]⁻, [CuCl₂]⁻, Cl⁻, Br⁻, F⁻, SCN⁻, and a fluorinated anion.

8. The method according to claim 1 wherein the cation is selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

9. The method according to claim 1 wherein the anion is selected from one or more members of the group consisting of acetate, aminoacetate, ascorbate, benzoate, catecholate, citrate, dialkylphosphate, formate, fumarate, gallate, glycolate, glyoxylate, iminodiacetate, isobutyrate, kojate, lactate, levulinate, oxalate, pivalate, propionate, pyruvate, salicylate, succinamate, succinate, tiglate, tetrafluoroborate, tetrafluoroethanesulfonate, tropolonate, [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO_{4]}⁻, [HSO_{3]}⁻, [CuCl₂]⁻, Cl⁻, Br⁻, I⁻, SCN⁻, [BF₄]⁻, [PF₆]⁻, [SbF₆], [CF₃SO₃]⁻, [HCF₂CF₂SO₃]⁻, [CF₃HFCCF₂SO_{3]}⁻, [HCClFCF₂SO_{3]}⁻, [(CF₃SO₂)₂N]⁻, [(CF₃CF₂SO₂)₂N]⁻, [(CF₃SO₂)₃C]⁻, [CF₃CO_{2]}⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃], [CF₃CF₂OCF₂CF₂SO₃]⁻, [(CF₂HCF₂SO₂)₂N], [(CF₃CFHCF₂SO₂)₂N]⁻, F⁻, and anions represented by the structure of the following formula: 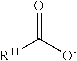
wherein R¹¹ is selected from the group consisting of:
(v) —CH₃, —C₂H₅, or C₃ to C₁₇ straight-chain, branched or cyclic alkane or alkene, optionally substituted with at least one member selected from the group consisting of Cl, Br, F, I, OH, NH₂ and SH;
(vi) —CH₃, —C₂H₅, or C₃ to C₁₇ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(vii) C₆ to C₁₀ unsubstituted aryl, or C₆ to C₁₇ unsubstituted heteroaryl having one to three heteroatoms independently selected from the group consisting of O, N, Si and S; and
(viii) C₆ to C₁₀ substituted aryl, or C₆ to C₁₇ substituted heteroaryl having one to three heteroatoms independently selected from the group consisting of O, N, Si and S; and wherein said substituted aryl or substituted heteroaryl has one to three substituents independently selected from the group consisting of:
(A) —CH₃, —C₂H₅, or C₃ to C₁₀ straight-chain, branched or cyclic alkane or alkene, optionally substituted with at least one member selected from the group consisting of Cl, Br, F, I, OH, NH₂ and SH,
(B) OH,
(C) 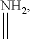
and
(D) SH.

10. The method according to claim 1 wherein the ionic liquid comprises at least one R group selected from the group consisting of: 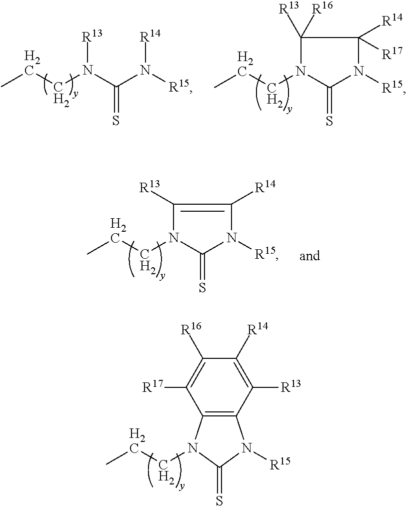
wherein R¹³˜R¹⁷ are as set forth in claim 1.

11. The method according to claim 1 wherein the ionic liquid comprises at least one additive selected from the group consisting of:
